(19) United States
(12) Patent Application Publication
(10) Pub. No.: US 2005/0204505 A1
(43) Pub. Date: Sep. 22, 2005

(54) Autonomous vacuum cleaner and autonomous vacuum cleaner network system

(75) Inventor: Yoshihiro Kashiwagi, Osaka (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co, Ltd., Daito-shi (JP)

(21) Appl. No.: 11/048,718

(22) Filed: Feb. 3, 2005

(30) Foreign Application Priority Data
Feb. 4, 2004 (JP) 2004-028081

(51) Int. Cl. A47L 5/00

(52) U.S. Cl. 15/319

(57) ABSTRACT

An autonomous vacuum cleaner network system comprises an autonomous vacuum cleaner and two terminal devices connected to the autonomous vacuum cleaner via a network. Using one of the terminal devices, a user inputs reservation information. The autonomous vacuum cleaner receives the input reservation information via a wireless LAN, and stores it, and further executes a self-diagnostic program immediately before a scheduled cleaning start time. If there is abnormality in the result of the self-diagnosis, the autonomous vacuum cleaner sends the result of the self-diagnosis as maintenance information to the other terminal device which is selected and assigned by the user as an addressed device. The autonomous vacuum cleaner network system makes it possible to set reservation information of the autonomous vacuum cleaner without requiring the user to go to the place where the autonomous vacuum cleaner is placed, and makes it possible to surely inform the user whether the autonomous vacuum cleaner can operate smoothly at the scheduled cleaning start time.

### BACKGROUND OF THE INVENTION

1. Field of the Invention

The present invention relates to an autonomous vacuum cleaner for cleaning a room while moving autonomously, and to an autonomous vacuum cleaner network system to form a network with the autonomous vacuum cleaner.

2. Description of the Related Art

In an autonomous vacuum cleaner for cleaning a floor surface in a house, it is known to use a timer function for automating not only a cleaning operation but also e.g. operations of starting and ending the cleaning. However, a self-standing autonomous vacuum cleaner usually becomes unattended after a scheduled cleaning start time is set. Accordingly, if, for example, a motor for moving the vacuum cleaner or a motor for sucking dust gets in trouble during the cleaning operation, the vacuum cleaner cannot continue a scheduled cleaning operation. Furthermore, only after a user goes to see the vacuum cleaner, expecting completion of the cleaning operation, the user can recognize that the vacuum cleaner has gotten in trouble. This is a problem in configuring a complete automatic cleaning system.

Further, in an autonomous vacuum cleaner having a cleaner main body for cleaning operation and a charging device for charging a battery of the cleaner main body, it is known to provide a reservation time setting unit for setting a scheduled cleaning start time in the charging device. The autonomous vacuum cleaner is designed such that when a user sets the scheduled cleaning start time, using the reservation time setting unit of the charging device, the user checks whether moving means and cleaning means of the cleaner main body operate normally so that the vacuum cleaner can operate smoothly at the scheduled cleaning start time (refer to e.g. Japanese Laid-open Patent Publications Hei 7-171078 and Hei 7-171081).

However, for setting the scheduled cleaning start time in the autonomous vacuum cleaner of either one of the two patent publications, the user is required to personally go to the place where the charging device is placed, because the cleaner main body and the charging device, which has the reservation time setting unit, are not connected via a network. This causes the operation of setting the reservation information to be laborious. Furthermore, since the user checks the operations of the moving means and the cleaning means of the cleaner main body at the time of setting the reservation information, there is no way for the user to be aware of any trouble occurring between the time of checking the operations and the scheduled cleaning start time. Thus, such autonomous vacuum cleaner is not necessarily a completely satisfactory one.

On the other hand, in an anomaly detection system for a mobile robot, it is known to store anomaly information in an inner memory of the robot when the anomaly of the robot is detected, and also known to store the anomaly information in an outer memory by sending the anomaly information outside the robot, using communication means, so as to be able to improve the reliability of anomaly detection (refer to e.g. Japanese Laid-open Patent Publication 2003-211380).

However, the technology disclosed in this patent publication does not make it possible to set reservation information using communication means, although it can send the anomaly information outside the robot using the communication means.

### SUMMARY OF THE INVENTION

An object of the present invention is to provide such an autonomous vacuum cleaner that makes it possible to set reservation information without requiring a user to go to the place where the autonomous vacuum cleaner is placed, and makes it possible to surely inform the user whether the autonomous vacuum cleaner can operate smoothly at a scheduled cleaning start time.

According to a first aspect of the present invention, there is provided an autonomous vacuum cleaner comprising: obstacle detection sensors, which are provided for autonomous movement of the autonomous vacuum cleaner, and which are provided for detecting obstacles each located in a moving direction of the autonomous vacuum cleaner and for measuring distances to the obstacles; a moving means for the autonomous movement of the autonomous vacuum cleaner while avoiding the obstacles based on a result of detection by the obstacle detection sensors; a cleaning means for cleaning an area in which the autonomous vacuum cleaner moves; a timer device for storing reservation information including scheduled cleaning start time and for managing time to start cleaning; and a communication module for making wireless communication with a terminal device which is connected to the autonomous vacuum cleaner via a network and which is provided for setting the reservation information, wherein the autonomous vacuum cleaner receives, using the communication module, the reservation information set by the terminal device, and stores the reservation information in the timer device, and further operates on the basis of the reservation information.

Another object of the present invention is to provide such an autonomous vacuum cleaner network system that can set reservation information without requiring a user to go to the place where the autonomous vacuum cleaner is placed, and can surely inform the user whether the autonomous vacuum cleaner can operate smoothly at a scheduled cleaning start time.

According to a second aspect of the present invention, there is provided an autonomous vacuum cleaner network system comprising: an autonomous vacuum cleaner and a terminal device connected to the autonomous vacuum cleaner via a network, the autonomous vacuum cleaner comprising: obstacle detection sensors, which are provided for autonomous movement of the autonomous vacuum cleaner, and which are provided for detecting obstacles each located in a moving direction of the autonomous vacuum cleaner and for measuring distances to the obstacles; a moving means for the autonomous movement of the autonomous vacuum cleaner while avoiding the obstacles based on a result of detection by the obstacle detection sensors; a cleaning means for cleaning an area in which the autonomous vacuum cleaner moves; a timer device for storing reservation information including scheduled cleaning start time and for managing time to start cleaning; and a first communication module for making wireless communication with the terminal device, and the terminal device comprising: a second communication module for making communication with the autonomous vacuum cleaner; a reservation information setting means for accepting setting of the reservation information of the autonomous vacuum cleaner; and a reservation information sending means for sending, using the second communication module, the reservation information set by the reservation information setting means to the autonomous vacuum cleaner, wherein the autonomous vacuum cleaner receives, using the first communication module, the reservation information set by the terminal device, and stores the reservation information in the timer device, and further operates on the basis of the reservation information.

While the novel features of the present invention are set forth in the appended claims, the present invention will be better understood from the following detailed description taken in conjunction with the drawings.

### BRIEF DESCRIPTION OF THE DRAWINGS

The present invention will be described hereinafter with reference to the annexed drawings. It is to be noted that all the drawings are shown for the purpose of illustrating the technical concept of the present invention or embodiments thereof, wherein:

FIG. 1 is a schematic perspective view of an autonomous vacuum cleaner according to an embodiment of the present invention;

FIG. 2 is a schematic electrical block diagram of the autonomous vacuum cleaner;

FIG. 3 is a schematic exploded perspective view of the autonomous vacuum cleaner;

FIG. 4 is a conceptual view of an autonomous vacuum cleaner network system according to an embodiment of the present invention;

FIG. 5A is a view for explaining a process until reservation information is stored in the autonomous vacuum cleaner, while FIG. 5B is a view for explaining a process until a result of self-diagnosis is sent from the autonomous vacuum cleaner; and

FIG. 6 is a flow chart showing a process of setting the reservation information in the autonomous vacuum cleaner network system and a process of the autonomous vacuum cleaner network system based on the set reservation information.

### DESCRIPTION OF THE PREFERRED EMBODIMENTS

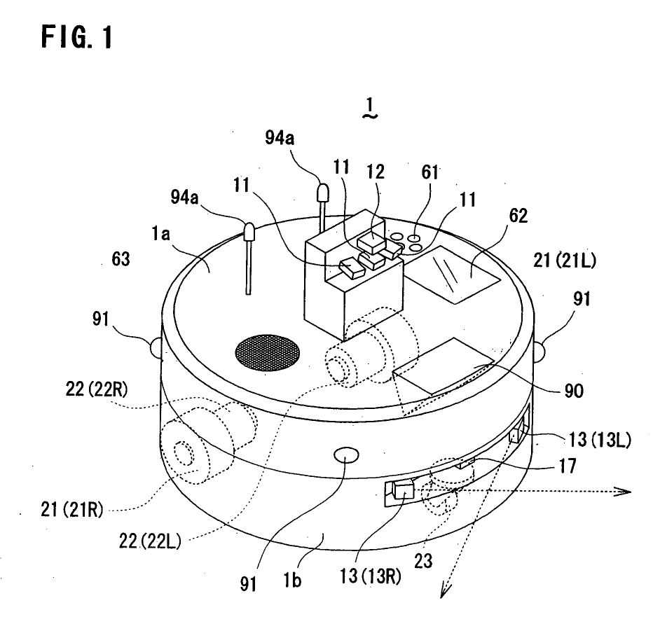

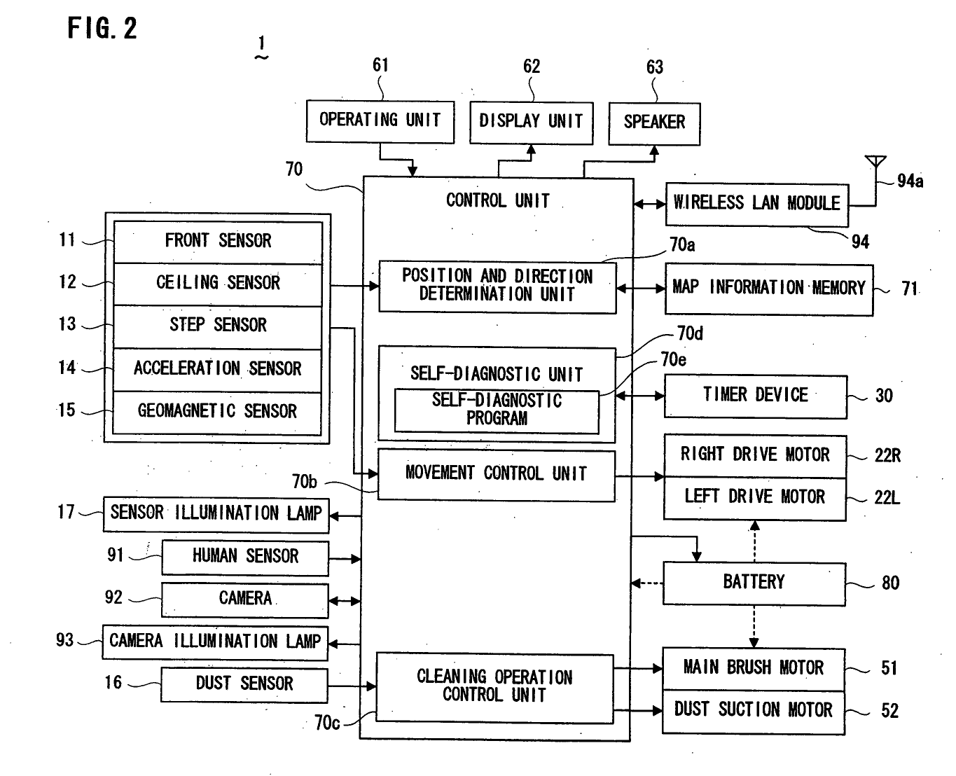

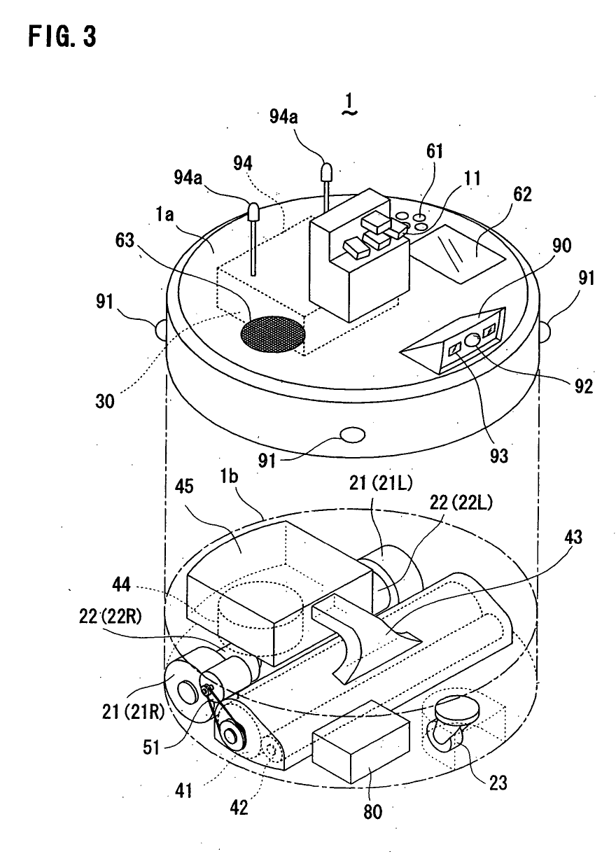

An embodiment of the present invention will be described hereinafter with reference to the annexed drawings. First, an autonomous vacuum cleaner 1 according to the embodiment will be described with reference to FIG. 1, FIG. 2 and FIG. 3, which show a perspective view, an electrical block diagram, and an exploded perspective view of the autonomous vacuum cleaner 1, respectively. The autonomous vacuum cleaner 1 is a device that judges place to clean on the basis of signals from e.g. multiple obstacle detection sensors 11, 12 and 13, and cleans a floor surface while autonomously moving, and that communicates with a later described terminal device or devices via wireless LAN (Local Area Network).

The autonomous vacuum cleaner 1 comprises obstacle detection sensors including: front sensors 11 and a ceiling sensor 12 that are provided on a projecting portion of an upper surface of a cleaner upper part 1a; and step sensors 13 with an illumination lamp 17 for the sensors that are provided on a front portion of a cleaner lower part 1b. The front sensors 11, the ceiling sensor 12 and the step sensors 13 are optical sensors which are provided for autonomous movement of the autonomous vacuum cleaner 1, and are provided for detecting obstacles each located in a moving direction of the autonomous vacuum cleaner 1 and for measuring distances to the obstacles.

More specifically, the front sensors 11 monitor the area in front of the autonomous vacuum cleaner 1 diagonally downward, and detect and further measure distances to obstacles such as a step, a wall, a pillar, a furniture, legs of a table and a bed, and so on. The ceiling sensor 12 monitors the space in front of the autonomous vacuum cleaner 1 diagonally upward, and detects obstacles located upward in front of the autonomous vacuum cleaner 1 (as to whether or not it can pass through under a table, a bed or the like), and further measures heights of and distances to the obstacles.

The step sensors 13 comprise a right step sensor 13R and a left step sensor 13L. The right step sensor 13R monitors the area slightly in front of and right of the autonomous vacuum cleaner 1 diagonally downward, and detects and further measures distances to obstacles. The left step sensor 13L monitors the area slightly in front of and left of the autonomous vacuum cleaner 1 diagonally downward, and detects and further measures distances to obstacles.

As other sensors for autonomous movement, the autonomous vacuum cleaner 1 further comprises an acceleration sensor 14 and a geomagnetic sensor 15 which are provided inside the cleaner upper part 1a. The acceleration sensor 14 independently detects accelerations in up-down direction, forward-backward direction and left-right direction, respectively, acting on the autonomous vacuum cleaner 1. The geomagnetic sensor 15 outputs output values according to the direction of the geomagnetic field to decide the then direction in which the autonomous vacuum cleaner 1 faces.

The autonomous vacuum cleaner 1 comprises a moving means for autonomous movement thereof while avoiding obstacles based on a result of detection by the obstacle detection sensors. The moving means comprises drive wheels 21 having a right drive wheel 21R and a left drive wheel 21L together with drive motors 22 having a right drive motor 22R and a left drive motor 22L that are positioned behind the cleaner lower part 1b in the moving direction of the autonomous vacuum cleaner 1. In addition to the drive wheels 21, the autonomous vacuum cleaner 1 comprises a front idler wheel 23 for its movement. The right drive wheel 21R and the left drive wheel 21L are independently rotated in normal rotation and reverse rotation by the right drive motor 22R and the left drive motor 22L, respectively, using a battery 80 as a power source, and are steered according to rotation speed control.

Referring now to FIG. 2 and FIG. 3, a cleaning means of the autonomous vacuum cleaner 1 will be described. In FIG. 3, the cleaner upper part 1a and the cleaner lower part 1b are shown as vertically separated. The cleaning means is provided for cleaning an area in which the autonomous vacuum cleaner 1 moves, and comprises a main brush 41, an idler roller 42, a suction nozzle 43, a dust suction fan 44 and a dust box 45 to collect dust. The main brush 41 is rotated by a main brush motor 51, while the dust suction fan 44 is rotated by a dust suction motor 52. The suction nozzle 43 sucks, from its suction opening, dust gathered up by the main brush 41 and dust transported by the idler roller 42, and collects both dusts into the dust box 45. The suction opening of the suction nozzle 43 is positioned at a bottom of the suction nozzle 43 which is directed to the floor surface, and has an open width elongated in a direction of the width of the autonomous vacuum cleaner 1 perpendicular to the moving direction of the autonomous vacuum cleaner 1. The autonomous vacuum cleaner 1 further comprises a dust sensor 16 for detecting dust sucked from the suction nozzle 43, wherein the dust sensor 16 is an optical transmission sensor having a light emitting unit and a light receiving unit.

The autonomous vacuum cleaner 1 further comprises an operating unit 61 to be operated by a user, a display unit 62, a speaker 63, a control unit 70, a map information memory 71, a timer device 30 and a battery 80.

The operating unit 61 is operated by a user to start and stop the cleaning operation of the autonomous vacuum cleaner 1, and to make various other settings. The display unit 62 is formed by e.g. an LCD (Liquid Crystal Display) or LED (Light Emitting Diode) to inform operational states of the autonomous vacuum cleaner 1 and various messages. The speaker 63 informs operational states of the autonomous vacuum cleaner 1 and various messages. The battery 80 supplies power to the whole of the autonomous vacuum cleaner 1 as shown by dashed arrows in FIG. 2.

The timer device 30 stores reservation information including scheduled cleaning start time as set by the user, and manages time to start executing a later described self-diagnostic program and time to start cleaning based on the reservation information with reference to the current time.

The control unit 70 controls each unit and element in the autonomous vacuum cleaner 1 based on signals input from e.g. the various sensors 11 to 16, and comprises a position and direction determination unit 70a, a movement control unit 70b and a cleaning operation control unit 70c. The control unit 70 further comprises a self-diagnostic unit 70d storing a self-diagnostic program 70e. The self-diagnostic unit 70d executes the self-diagnostic program 70e based on a signal from the timer device 30 before, preferably immediately before, the scheduled cleaning start time so as to self-diagnose with reference to the reservation information stored in the timer device 30 whether the moving means and the cleaning means can operate normally. The self-diagnostic unit 70d further sends, using a later described wireless LAN module (first communication module) 94, the result of the self-diagnosis performed thereby to a terminal device or devices assigned in advance by the user. In other words, by the self-diagnostic program 70e being executed, the control unit 70 functions as a self-diagnostic means as well as a diagnostic result sending means. Here, it is to be noted that the time “immediately before” the scheduled cleaning start time is decided according to time required for the self-diagnosis so as to be able to start the cleaning operation immediately after the self-diagnosis, and is preferably between a few tens of minutes and a few minutes before the scheduled cleaning start time.

Based on outputs of the front sensors 11, the ceiling sensor 12 and the step sensors 13, the position and direction determination unit 70a creates map information about an area in which an obstacle exists and about an already cleaned area, and causes the map information memory 71 to store the thus created map information. The position and direction determination unit 70a further calculates a moving speed of the autonomous vacuum cleaner 1 by time-integrating an acceleration detection value of the acceleration sensor 14 in the forward-backward direction, and also calculates a moving distance based on the thus calculated moving speed and moving time. Furthermore, based on an output value of the geomagnetic sensor 15 according to the direction of the geomagnetic field, the position and direction determination unit 70a determines a direction in which the autonomous vacuum cleaner 1 faces.

The movement control unit 70b rotates and controls the drive motors 22 for controlling the rotational directions and rotational speeds of the drive wheels 21 so as to control the movement of the autonomous vacuum cleaner 1 for autonomous movement of the autonomous vacuum cleaner 1 while avoiding obstacles. The autonomous vacuum cleaner 1 moves with reference to the map information in the map information memory 71 to perform the cleaning operation, in which the map information is renewed as needed during the cleaning operation. The cleaning operation control unit 70c controls the rotations of the main brush motor 51 and the dust suction motor 52, which rotates the dust suction fan 44, so as to adjust the power to collect and suck dust.

The autonomous vacuum cleaner 1 furthermore has a security function of monitoring e.g. an intruder, and for this purpose comprises a human sensor or sensors 91 to detect human presence such as an intruder, and a camera unit 90 having a camera 92 and camera illumination lamps 93 for photographing a situation including e.g. the intruder when the human sensor responds. The human sensor 91 detects presence or absence of a human body around the autonomous vacuum cleaner 1 by receiving infrared radiation from the human body. The camera 92 is provided to face in a direction diagonally forward and upward from the autonomous vacuum cleaner 1 so that they can photograph faces of standing humans. Note that when not in use, the camera unit 90 having the camera 92 and the camera illumination lamps 93 is contained inside the autonomous vacuum cleaner 1 (refer to FIG. 1), while it comes up when in use (refer to FIG. 3).

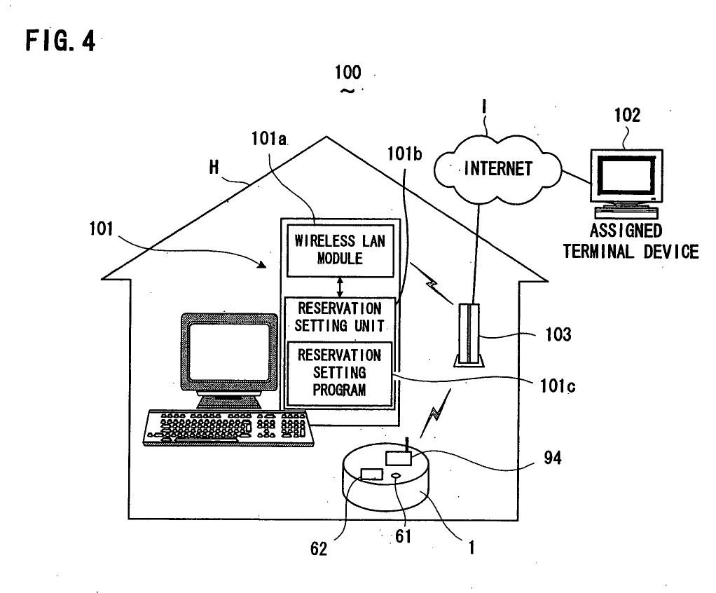

The autonomous vacuum cleaner 1 comprises a wireless LAN module 94 for making mutual wireless communication with later described terminal device 101 and further terminal device 102 (refer to FIG. 4) so as to receive reservation information sent from the terminal device 101 and to send the result of the self-diagnosis to the further terminal device 102. The wireless LAN module 94 wirelessly sends images photographed by the camera 92 and operational states of the autonomous vacuum cleaner 1 to e.g. the terminal devices 101 and 102 via an antenna 94a. When not in the cleaning operation, the autonomous vacuum cleaner 1 operates these human sensors 91, camera 92, camera illumination lamps 93 and wireless LAN module 94 so as to monitor e.g. intruders.

The following describes an autonomous vacuum cleaner network system 100 with reference to FIG. 4 which shows its conceptual view. As shown in FIG. 4, an autonomous vacuum cleaner network system 100 comprises an autonomous vacuum cleaner 1 and terminal devices 101 and 102 connected to the autonomous vacuum cleaner 1 via a network. The terminal device 101, which is provided for setting reservation information, comprises a wireless LAN module (second communication module) 101a and a reservation setting unit 101b, and is placed in a house H in which the autonomous vacuum cleaner 1 is used. The terminal device 101 executes a reservation setting program 101c stored in the reservation setting unit 101b so as to accept setting, by a user, of reservation information including a scheduled cleaning start time, and sends the set reservation information to the autonomous vacuum cleaner 1 using the wireless LAN module 101a via a wireless LAN terminal 103. In other words, by executing the reservation setting program 101c, the reservation setting unit 101b functions as a reservation information setting means as well as a reservation information sending means. The further terminal device 102, assigned as an addressed device for receiving the result of the self-diagnosis, is placed outside the house H and communicates with the autonomous vacuum cleaner 1 via internet I.

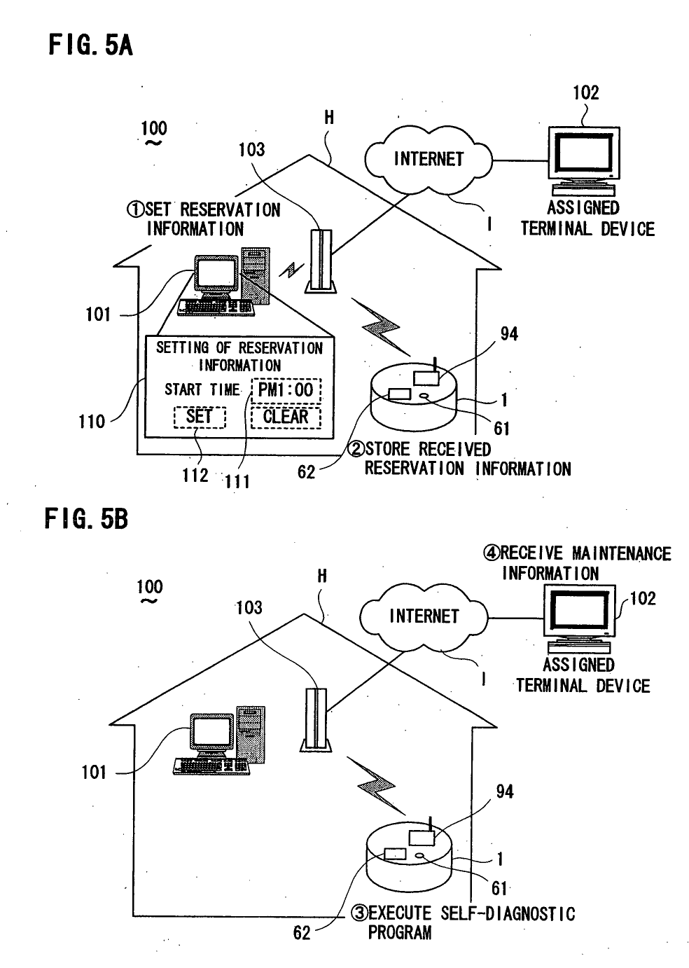

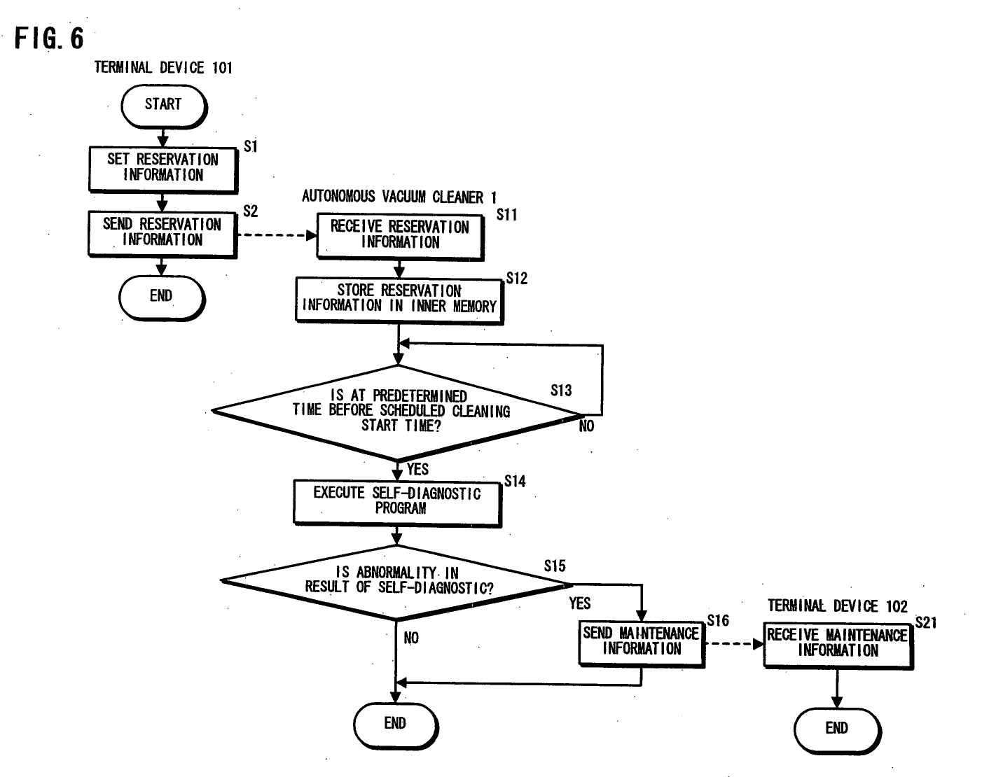

The following describes a process of setting reservation information, using the autonomous vacuum cleaner network system 100, and a process of the autonomous vacuum cleaner network system 100 based on the set reservation information. Referring to FIG. 5A which is a view for explaining a process until the reservation information is stored in the autonomous vacuum cleaner 1, and to FIG. 6 which is a flow chart showing a process of setting reservation information in the autonomous vacuum cleaner network system 100 and a process of the autonomous vacuum cleaner network system 100 based on the set reservation information, the terminal device 101 first accepts input of reservation information when the reservation setting program 101c is executed (S1). A user inputs reservation information such as scheduled cleaning start time 111, using the terminal device 101 placed in e.g. a study room while watching a monitor screen 110. After completing the input of the reservation information, the user presses a set button 112 to set the reservation information.

When the set button 112 is pressed, the terminal device 101 sends the reservation information to the autonomous vacuum cleaner 1 via the wireless LAN terminal 103 (S2). The autonomous vacuum cleaner 1 receives the reservation information using the wireless LAN module 94 (S11), and stores the received reservation information in an inner memory of the timer device 30 (S12). The autonomous vacuum cleaner operates on the basis of the reservation information. More specifically, with reference to the stored reservation information and the current time, the timer device 30 judges whether or not it is at a predetermined time before the scheduled cleaning start time (S13). At the predetermined time before the scheduled cleaning start time (YES in S13), the timer device 30 outputs a signal to the control unit 70.

As shown in the flow chart of FIG. 6 and in FIG. 5B which is a view for explaining a process until the result of the self-diagnosis is sent from the autonomous vacuum cleaner 1, the control unit 70 executes the self-diagnostic program according to the signal from the timer device 30, and self-diagnoses whether or not there is abnormality in the moving means or the cleaning means (S14). If there is abnormality in the result of the self-diagnosis (YES in S15), the control unit 70 sends the result of the self-diagnosis as maintenance information to the further terminal device 102 which is selected and assigned by the user as the addressed device (S16), whereby the self-diagnosis is completed. If there is no abnormality in the result of the self-diagnosis (NO in S15), the process ends without any further step. The further terminal device 102 receives the maintenance information sent from the autonomous vacuum cleaner 1 via the internet I (S21). Note that the contents of the self-diagnosis include: checking the operation of the moving means to be performed by rotating the drive motors 22 in a predetermined pattern; checking the operation of the cleaning means to be performed by rotating the main brush motor 51 and the dust suction motor 52 in a predetermined pattern; checking the remaining capacity of the battery 80; checking the amount of dust remaining in the dust box 45; and so on. The user sets its desired contents of the self-diagnosis when setting reservation information.

As described hereinabove, in the autonomous vacuum cleaner 1 and the autonomous vacuum cleaner network system 100 according to the present embodiment, reservation information set by a user using the reservation setting program 101c in the terminal device 101 is sent to the autonomous vacuum cleaner 1 via a wireless LAN, and the autonomous vacuum cleaner 1 is operated in accordance with the thus sent reservation information. Accordingly, it is possible to set reservation information without requiring the user to go to the place where the autonomous vacuum cleaner 1 is placed. For example, by operating e.g. a personal computer placed in a study room, the user can set reservation information of an autonomous vacuum cleaner 1 placed in a living room. Further, although the autonomous vacuum cleaner 1 is limited in the number of buttons of the operating unit 61 and in the size of the display unit 62, depending on the design and size of the autonomous vacuum cleaner 1, there is no such limitation in the terminal device 101 such as a personal computer. Thus, in the case of the terminal device 101, it is possible to easily set the reservation information of the autonomous vacuum cleaner 1, using a convenient and easy-to-use user interface such as a keyboard, a mouse or a large size monitor.

Furthermore, using the self-diagnostic program 70e before a scheduled cleaning start time, the autonomous vacuum cleaner 1 according to the present embodiment self-diagnoses whether the moving means and the cleaning means can operate normally, and sends the result of the self-diagnosis to the further terminal device 102 which is assigned in advance by the user. Accordingly, it is not required for the user to monitor whether the autonomous vacuum cleaner 1 can operate smoothly at the scheduled cleaning start time.

In addition, by performing the self-diagnosis immediately before the scheduled cleaning start time, it is possible to reduce the time between the time of self-diagnosis and the scheduled cleaning time, thereby making it possible to reduce the probability of occurrence of a trouble in the autonomous vacuum cleaner 1 between the two times. Accordingly it is possible to surely inform the user whether or not the autonomous vacuum cleaner 1 can operate smoothly at the scheduled cleaning start time. For example, there is a case where the battery 80 in the autonomous vacuum cleaner 1 is not completely charged at the scheduled cleaning start time to the extent to enable a reserved cleaning operation even if the battery 80 is subjected to charging to the time immediately before the scheduled cleaning start time. This is because usually it takes a long time to charge the battery 80. In such case, it is possible to check the remaining capacity of the battery 80 by executing the self-diagnostic program 70c, and to inform the user that the remaining capacity of the battery 80 is not sufficient.

It is to be noted that the present invention is not limited to the structure, configuration or process of the above embodiment, and various modifications are possible. For example, although a wireless LAN module is used for the communication module in the above embodiment, other wireless communication modules can also be used for the communication module.

The present invention has been described above using presently preferred embodiments, but such description should not be interpreted as limiting the present invention. Various modifications will become obvious, evident or apparent to those ordinarily skilled in the art, who have read the description. Accordingly, the appended claims should be interpreted to cover all modifications and alterations which fall within the spirit and scope of the present invention.

1. An autonomous vacuum cleaner comprising:
obstacle detection sensors, which are provided for autonomous movement of the autonomous vacuum cleaner, and which are provided for detecting obstacles each located in a moving direction of the autonomous vacuum cleaner and for measuring distances to the obstacles;
a moving means for the autonomous movement of the autonomous vacuum cleaner while avoiding the obstacles based on a result of detection by the obstacle detection sensors;
a cleaning means for cleaning an area in which the autonomous vacuum cleaner moves;
a timer device for storing reservation information including scheduled cleaning start time and for managing time to start cleaning; and
a communication module for making wireless communication with a terminal device which is connected to the autonomous vacuum cleaner via a network and which is provided for setting the reservation information,
wherein the autonomous vacuum cleaner receives, using the communication module, the reservation information set by the terminal device, and stores the reservation information in the timer device, and further operates on the basis of the reservation information.

2. The autonomous vacuum cleaner according to claim 1, which further comprises:
a self-diagnostic means for self-diagnosing, at a predetermined time before the scheduled cleaning start time with reference to the reservation information stored in the timer device, whether the moving means and the cleaning means can operate normally; and
a diagnostic result sending means for sending, using the communication module, the result of the self-diagnosis performed by the self-diagnostic means to a further terminal device assigned in advance by a user.

3. The autonomous vacuum cleaner according to claim 2, wherein the self-diagnostic means self-diagnoses immediately before the scheduled cleaning start time.

4. The autonomous vacuum cleaner according to claim 3, which further comprises:
a human sensor for detecting human presence such as an intruder; and
a camera for photographing a situation when the human sensor responds.

5. An autonomous vacuum cleaner network system comprising an autonomous vacuum cleaner and a terminal device connected to the autonomous vacuum cleaner via a network,
the autonomous vacuum cleaner comprising:
obstacle detection sensors, which are provided for autonomous movement of the autonomous vacuum cleaner, and which are provided for detecting obstacles each located in a moving direction of the autonomous vacuum cleaner and for measuring distances to the obstacles;
a moving means for the autonomous movement of the autonomous vacuum cleaner while avoiding the obstacles based on a result of detection by the obstacle detection sensors;
a cleaning means for cleaning an area in which the autonomous vacuum cleaner moves;
a timer device for storing reservation information including scheduled cleaning start time and for managing time to start cleaning; and
a first communication module for making wireless communication with the terminal device, and
the terminal device comprising:
a second communication module for making communication with the autonomous vacuum cleaner;
a reservation information setting means for accepting setting of the reservation information of the autonomous vacuum cleaner; and
a reservation information sending means for sending, using the second communication module, the reservation information set by the reservation information setting means to the autonomous vacuum cleaner,
wherein the autonomous vacuum cleaner receives, using the first communication module, the reservation information set by the terminal device, and stores the reservation information in the timer device, and further operates on the basis of the reservation information.

6. The autonomous vacuum cleaner network system according to claim 5, wherein the autonomous vacuum cleaner further comprises:
a self-diagnostic means for self-diagnosing, at a predetermined time before the scheduled cleaning start time with reference to the reservation information stored in the timer device, whether the moving means and the cleaning means can operate normally; and
a diagnostic result sending means for sending, using the first communication module, the result of the self-diagnosis performed by the self-diagnostic means to a further terminal device assigned in advance by a user.

7. The autonomous vacuum cleaner network system according to claim 6, wherein the self-diagnostic means of the autonomous vacuum cleaner self-diagnoses immediately before the scheduled cleaning start time.

8. The autonomous vacuum cleaner network system according to claim 7, wherein the autonomous vacuum cleaner further comprises:
a human sensor for detecting human presence such as an intruder; and
a camera for photographing a situation when the human sensor responds.
